(19) United States
(12) Patent Application Publication
(10) Pub. No.: US 2009/0295344 A1
(43) Pub. Date: Dec. 3, 2009

(54) POWER-REGULATOR CIRCUIT HAVING TWO OPERATING MODES

(75) Inventor: Dayu Qu, Sunnyvale, CA (US)

Correspondence Address: PVF -- APPLE INC.;c/o PARK, VAUGHAN & FLEMING LLP, 2820 FIFTH STREET, DAVIS, CA, 95618-7759, US

(73) Assignee: Apple Inc., Cupertino, CA (US)

(21) Appl. No.: 12/128,826

(22) Filed: May 29, 2008

(51) Int. Cl. G05F 1/00

(52) U.S. Cl. 323/265

(57) ABSTRACT

Embodiments of a power-regulator circuit having two operating modes are described. This power-regulator circuit includes control logic that is configured to select a given operating mode based on a load condition of the power-regulator circuit. During a first operating mode, the control logic provides a first signal that operates the power-regulator circuit as a linear regulator. Moreover, during a second operating mode, the control logic provides a second signal and a third signal that operate the power-regulator circuit as a switch-mode regulator.

### BACKGROUND

1. Field of the Invention

The present invention relates to power-regulation techniques. More specifically, the present invention relates to a power-regulator circuit having load-dependent operating modes.

2. Related Art

Recent increases in the computational performance and functionality of electronic devices have resulted in commensurate increases in power consumption and associated heat generation of these devices. Consequently, managing the ‘thermal load’ associated with the power consumption to maintain acceptable internal and external operating temperatures has become a considerable challenge. In addition, many electronic devices, such as portable electronic devices (for example, laptop computers or notebook PCs, cellular telephones, and personal digital assistants) are powered by batteries that can only store a limited amount of charge. As the power consumption of these devices increases, this limited charge storage capability results in reduced operating time between recharges. Therefore, reducing power consumption in such electronic devices has become increasingly important design consideration.

Most electronic devices include multiple power-regulator circuits to provide regulated voltages (such as DC voltages) to integrated circuits or chips within the devices. For example, FIG. 1 presents a block diagram illustrating these circuits in an existing portable electronic device 100. In this electronic device, adaptor 110 provides a voltage to power-regulator circuit 112. This circuit charges battery 116 and powers bus 114, which is coupled to additional power-regulator circuits, such as: CPU Vcore regulator 118, GPU Vcore regulator 120, memory regulator 122, 5 V regulator 124, 3.3 V regulator 126, and/or 1.05 V regulator 128. Note that the output voltage from power-regulator circuit 112 may depend on the charge stored on the battery 116.

Typically, power-regulator circuit 112 is designed to reduce power loss under heavy load conditions which occur during normal operation of portable electronic device 100. However, when the portable electronic device 100 is in the OFF or SLEEP operating modes, most of the additional power-regulator circuits are turned off or under very light load.

Unfortunately, the efficiency of many power-regulator circuits, such as power-regulator circuit 112, under such light load conditions is very poor. This is shown in FIG. 2, which presents a graph 200 of an efficiency curve (plotted as efficiency 210 versus load current 212) for a typical power-regulator circuit, such as power-regulator circuit 112 in FIG. 1. For example, a power-regulator circuit, such as power-regulator circuit 112 (FIG. 1), may have an efficiency of 30% for load currents 212 between 10-100 mA. Because the total system power passes through power-regulator circuit 112 (FIG. 1), this inefficiency significantly reduces the power efficiency of portable electronic device 100 (FIG. 1).

Hence, what is needed are power-regulation techniques that overcome the problems listed above.

### SUMMARY

One embodiment of the present invention provides a power-regulator circuit having two operating modes. This power-regulator circuit includes control logic that is configured to select a given operating mode based on a load condition of the power-regulator circuit. Note that, during a first operating mode, the control logic provides a first signal that operates the power-regulator circuit as a linear regulator. Moreover, during a second operating mode, the control logic provides a second signal and a third signal that operate the power-regulator circuit as a switch-mode regulator.

In some embodiments, the power-regulator circuit includes a linear regulator circuit, a switch-mode regulator circuit and a first power transistor coupled to a first node of the power-regulator circuit (which is configured to receive an input voltage). It also includes a switch, which is coupled to the control logic, the linear-regulator circuit and the switch-mode regulator circuit. This switch selectively couples the first signal from the linear regulator circuit to the first power transistor during the first operating mode and selectively couples the second signal from the switch-mode regulator circuit to the first power transistor during the second operating mode.

In some embodiments, the linear regulator circuit includes a low-dropout regulator circuit and/or the switch-mode regulator circuit includes a buck regulator circuit. Moreover, the second signal from the switch-mode regulator circuit may include a pulse-width modulated signal.

In some embodiments, the power-regulator circuit includes a second power transistor coupled in series with the first power transistor and coupled to a second node of the power-regulator circuit which is configured to couple to a reference voltage, such as ground or a virtual ground. Moreover, an inverter, coupled to the control logic, selectively provides the third signal to the second power transistor during the second operating mode, where the third signal is the inverse of the second signal.

Note that the output from the inverter may be selectively disabled during the first operating mode. For example, during the first operating mode, the output from the inverter may be selectively set to a lower impedance than during the second operating mode.

In some embodiments, the first power transistor is shared during the first operating mode and the second operating mode. Moreover, the second power transistor may be inactive during the first operating mode.

In some embodiments, the power-regulator circuit provides an output voltage at a third node between the first power transistor and the second power transistor.

Note that the load condition may correspond to a current at the third node. Moreover, the first operating mode may have a higher efficiency, which corresponds to the input voltage and the output voltage, than the second operating mode for values of the current less than a threshold, such as approximately 100 mA. In some embodiments, the output voltage may be provided by at most the first power transistor and the second power transistor during the two operating modes.

In some embodiments, the power-regulator circuit is included in a portable electronic device, such as a laptop computer.

In some embodiments, the power-regulator circuit is disposed on an integrated circuit.

Another embodiment provides the portable electronic device.

Another embodiment provides a computer-readable medium containing data representing the power-regulator circuit.

Another embodiment provides a method for regulating power using a power-regulator circuit that has two operating modes. During the method, a load condition of the power-regulator circuit is monitored and a given operating mode is selected based on a load condition. Then, one or more signals to operate the power-regulator circuit are generated. Note that, during a first operating mode, the one or more signals include a first signal that operates the power-regulator circuit as a linear regulator. Moreover, during a second operating mode, the one or more signals include a second signal and a third signal that operate the power-regulator circuit as a switch-mode regulator.

### BRIEF DESCRIPTION OF THE FIGURES

FIG. 1 is a block diagram illustrating an existing portable electronic device.

FIG. 2 is a graph of an efficiency curve for a typical power-regulator circuit.

FIG. 3 is a block diagram of a power-regulator circuit in accordance with an embodiment of the present invention.

FIG. 4 is a block diagram of a low-dropout regulator circuit in accordance with an embodiment of the present invention.

FIG. 5 is a block diagram of a switch-mode regulator in accordance with an embodiment of the present invention.

FIG. 6 is a block diagram of a power-regulator circuit in accordance with an embodiment of the present invention.

FIG. 7 is a graph of an efficiency curve for a power-regulator circuit in accordance with an embodiment of the present invention.

FIG. 8 is a block diagram illustrating a portable electronic device in accordance with an embodiment of the present invention.

FIG. 9 is a flowchart illustrating a process for regulating power using a power-regulator circuit that has two operating modes in accordance with an embodiment of the present invention.

FIG. 10 is a block diagram of a system in accordance with an embodiment of the present invention.

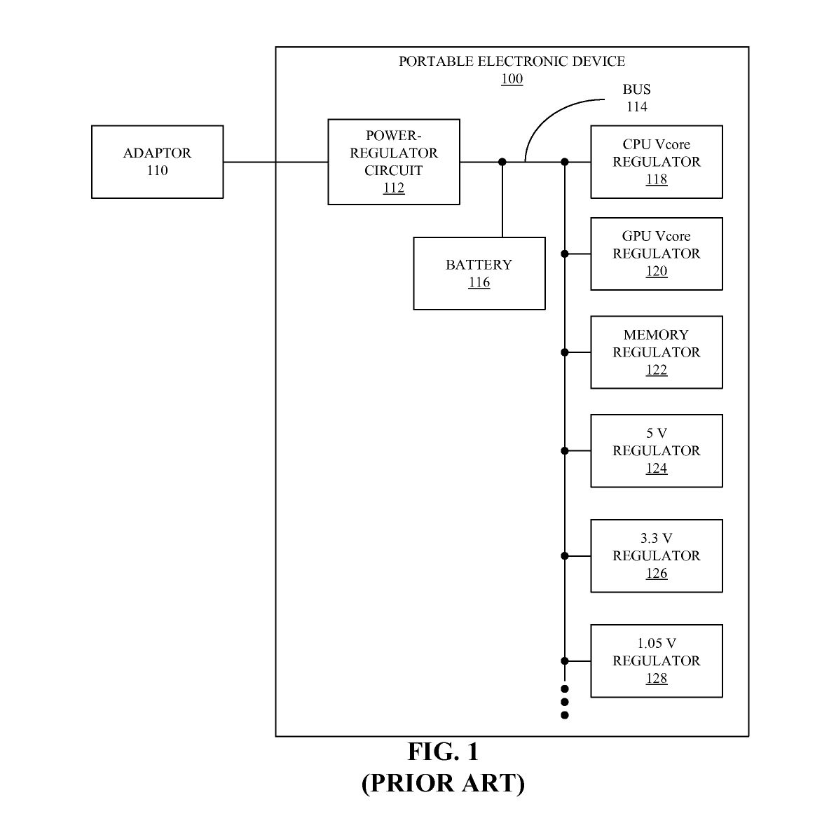

Note that like reference numerals refer to corresponding parts throughout the drawings.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Embodiments of a power-regulator circuit, a computer system and/or a portable electronic device that includes the power-regulator circuit, and a method for regulating power are described. This power-regulator circuit is configured to operate as a linear regulator or a switch-mode regulator based on a load condition of the power-regulator circuit. In particular, when the power-regulator circuit is subject to a light load condition (such as a load current less than 100 mA), the power-regulator circuit may be operated as a linear regulator (e.g., a low dropout regulator). However, when the load current exceeds a threshold (such as 100 mA), the power-regulator circuit may be operated as a switch-mode regulator (such as a buck regulator).

This configuration may allow the power-regulator circuit to utilize fewer components and, thus, to have a reduced cost. For example, the two operating modes may share one or more power transistors. Moreover, in some embodiments the output from the power-regulator circuit is provided using only two power transistors.

Additionally, by adapting the operating mode based on the load condition, the power-regulator circuit may have significantly improved efficiency, especially at low load conditions. This increase in efficiency may reduce power loss, which may increase the operating time for a given battery charge in portable electronic devices, such as laptop computers.

Note that the computer system and/or the portable electronic device may include: a server, a laptop computer, a personal computer, a work station, a mainframe computer, a digital signal processor, a portable-computing device, a personal organizer, a cellular telephone, a personal digital assistant, a game console, an MP3 player, a device controller, and/or a computational engine within an appliance.

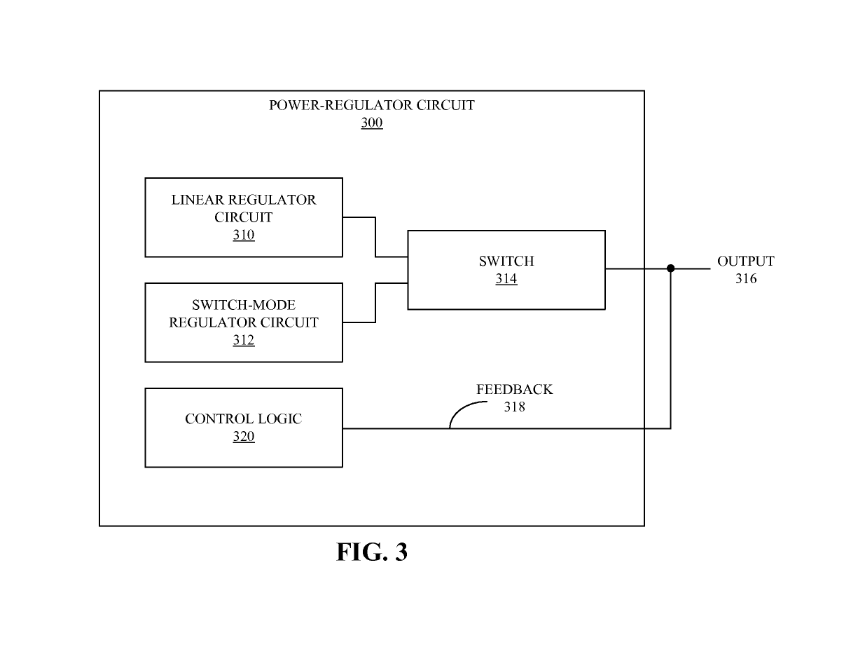

We now describe embodiments of the power-regulator circuit. FIG. 3 presents a block diagram of a power-regulator circuit 300 that has two operating modes. In particular, control logic 320 selects a given operating mode based on a load condition of the power-regulator circuit 300 (for example, based on feedback 318 from an output 316). For example, under light load conditions, linear regulator circuit 310 may be more efficient than switch-mode regulator circuit 312, and under heavy load conditions, switch-mode regulator circuit 312 may be more efficient than linear regulator circuit 3 10. Consequently, during a first operating mode, control logic 320 may configure switch 314 such that linear regulator circuit 310 provides the output 316. Moreover, during a second operating mode, control logic 320 may configure switch 314 such that switch-mode regulator circuit 312 provides the output 316.

In an exemplary embodiment, the linear regulator circuit 310 includes a low dropout regulator (LDO) and the switch-mode regulator circuit 312 includes a buck regulator circuit.

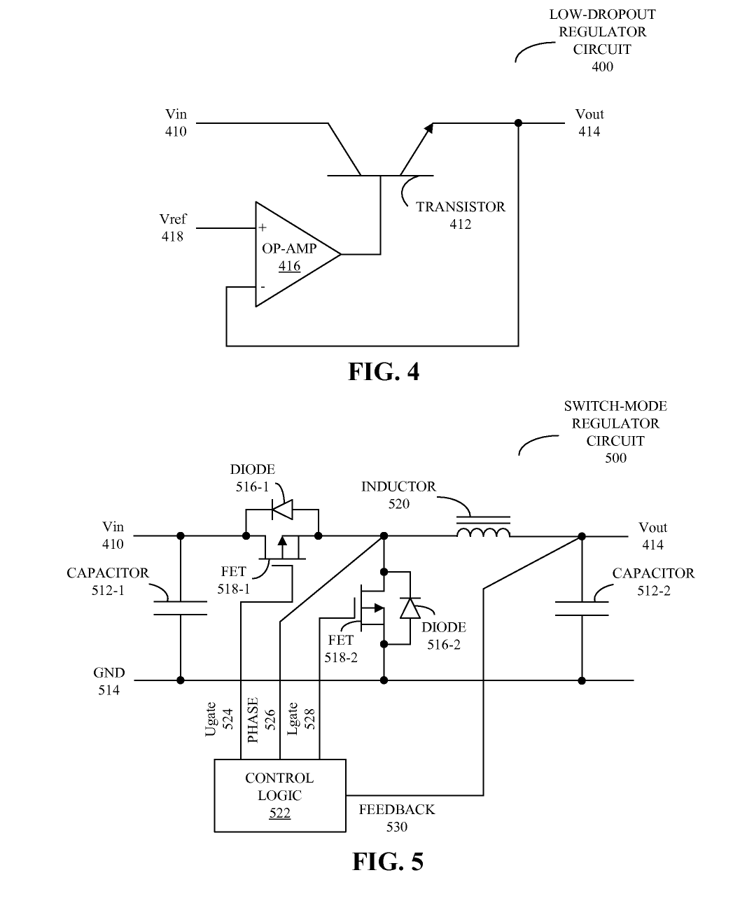

FIG. 4 presents a block diagram of an LDO circuit 400. In this circuit, a transistor 412 (such as a bipolar transistor or a field-effect transistor) adjusts the flow of current between an input voltage (Vin) 410 and an output voltage (Vout) 414. Based on a comparison of Vout 414 and a reference voltage (Vref) 418, operational amplifier 416 adjusts a voltage on a gate of transistor 412. When Vout 414 is higher than Vref 418, the voltage on the gate is reduced, and when Vout 414 is lower than Vref 418, the voltage on the gate is increased.

Note that LDO circuit 400 operates in linear mode. Moreover, note that the efficiency of LDO circuit 400 can be expressed as

$$\frac{{V}_{out}}{{V}_{i n}} ,$$

which is independent of the load current.

FIG. 5 presents a block diagram of a switch-mode regulator 500, (which is a buck regulator). In this circuit, control logic 522 provides signals Ugate 524 and Lgate 528 based on phase 526 and feedback 530 (which is determined at Vout 414). Ugate 524 and Lgate 528 are complementary pulse-width modulated pulses. Consequently, field-effect transistors (FETs) 518 never turn on at the same time.

Moreover, the switching of FETs 518 results in a square-wave pulse signal, phase 526, having an amplitude equal to Vin 410 and a width controlled by the pulse width of Ugate 524 and Lgate 528. This pulse is filtered by inductor 520 and capacitor 512-2 to provide DC voltage Vout 414 relative to ground (GND) 514. Note that capacitor 512-1 filters Vin 410, and that diodes 516 restrict the back-emf voltage across FETs 518.

In switch-mode regulator 500, FETs 518 operate in switching mode. Moreover, the power-converting efficiency can be expressed as

$$\frac{{P}_{out}}{{P}_{out} + {P}_{loss}} ,$$

i.e., output power over input power (which equals the output power plus power loss). Note that the power loss of a buck regulator includes switching loss and conduction loss. Switching loss is a function of the switching frequency and the charge on the gates of FETs 518, both of which are determined by the circuit design and are not directly related to the load current. However, the conduction loss is determined by the load current. As noted previously, at high load currents a buck regulator can have a high power-converting efficiency. Unfortunately, at low load currents the power-converting efficiency is very low. By combining an LDO circuit 400 with a switch-mode regulator 500, power-regulator circuit 300 (FIG. 3) can offer high efficiency over a wide range of load conditions.

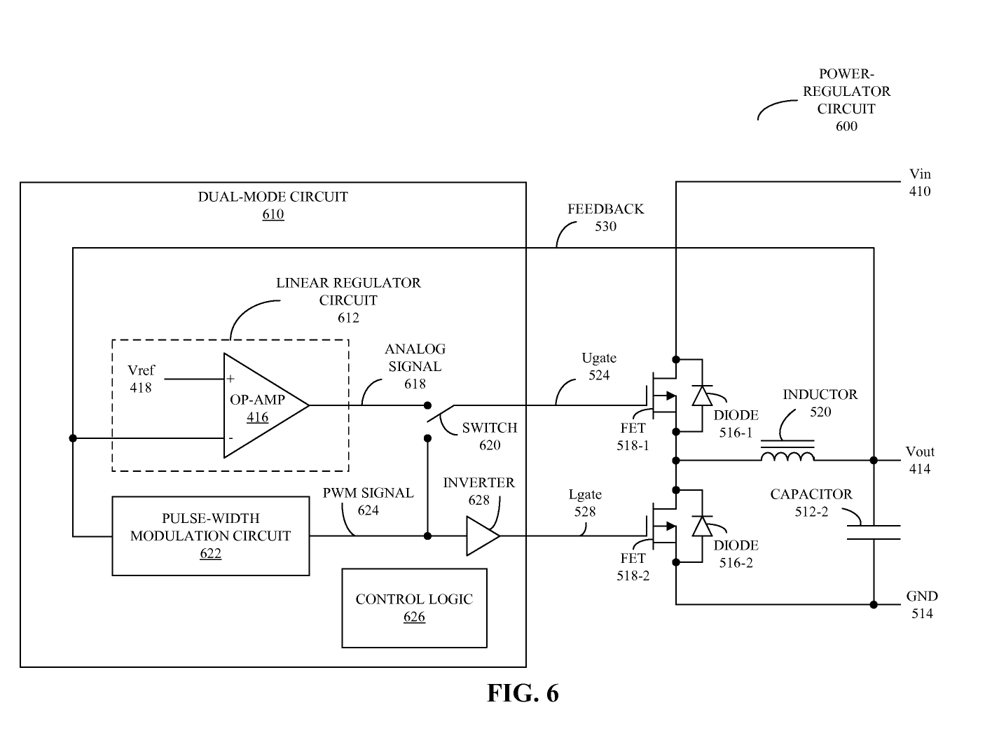

We now describe exemplary embodiments of the power-regulator circuit. FIG. 6 presents a block diagram of a power-regulator circuit 600 that has two operating modes which are selected based on a load condition (such as current at Vout 414). During the first operating mode, control logic 626 in dual-mode circuit 610 configures switch 620 so that the Ugate 524 signal applied to the gate of FET 518-1 (and more generally, the gate of a power transistor) is provided by analog signal 618 from operational amplifier 416 in linear regulator circuit 612. Thus, during the first operating mode, dual-mode circuit 610 provides a first signal, Ugate 524, that operates the power-regulator circuit 600 as a linear regulator which outputs Vout 414 relative to GND 514. Note that GND 514 may be ground or a virtual ground.

During the second operating mode, control logic 626 configures switch 620 so that the Ugate 524 signal applied to the gate of FET 518-1 is pulse-width-modulated (PWM) signal 624 provided by PWM circuit 622. Moreover, inverter 628 provides Lgate 528 signal (which is the inverse of PWM signal 624) to the gate of FET 518-2 (and more generally, to the gate of a second power transistor). Thus, during the second operating mode, dual-mode circuit 610 provides a second signal, Ugate 524, and a third signal, Lgate 528, that operate the power-regulator circuit 600 as a switch-mode regulator which outputs Vout 414 relative to GND 514.

Note that during the first operating mode, inverter 628 may be selectively disabled by control logic 626. For example, an output node of inverter 628 may be selectively set to a low impedance, such as ground. Moreover, note that FET 518-2 may be inactive during the first operating mode.

In addition to providing high efficiency over a wide range of load conditions, power-regulator circuit 600 uses fewer components than separate implementations of the LDO circuit and the switch-mode regulator circuit and, therefore, reduces cost. In particular, FET 518-1 is shared in the two operating modes. Additionally, in some embodiments power-regulator circuit 600 only includes two FETs 518 or, more generally, two power transistors, to provide Vout 414.

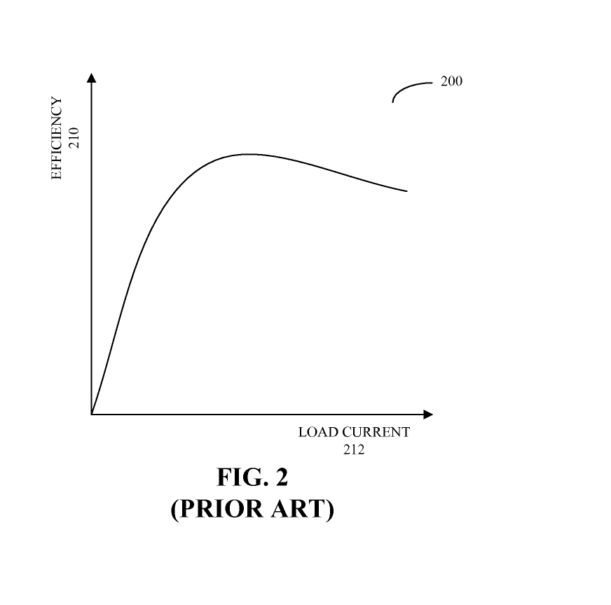

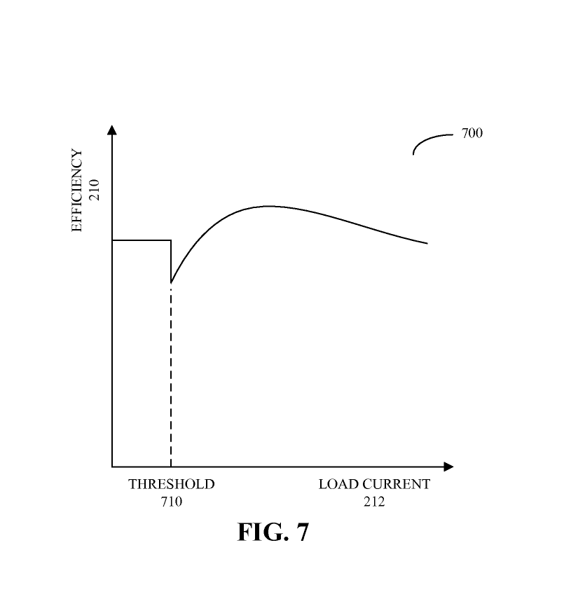

FIG. 7 presents a graph 700 of an efficiency curve for a power-regulator circuit, such as power-regulator circuits 300 (FIG. 3) and 600 (FIG. 6). Note that for load currents 212 less than threshold 710, efficiency 210 is improved relative to that shown in FIG. 2.

In an exemplary embodiment, threshold 710 is approximately 100 mA. At high load currents 212 (i.e., those greater than 100 mA) the efficiency 210 approaches 96%, and at low load currents 212 (i.e., those less than 100 mA) the efficiency 210 is 76.4%.

In some embodiments, power-regulator circuit 300 (FIG. 3), LDO circuit 400 (FIG. 4), switch-mode regulator circuit 500 (FIG. 5), and power-regulator circuit 600 (FIG. 6) include fewer or additional components. Moreover, two or more components are combined into a single component and/or a position of one or more components may be changed.

Components and/or functionality illustrated in these embodiments may be implemented using analog circuits and/or digital circuits. Moreover, power transistors may be bipolar or FETs, and may used PMOS and/or NMOS. Furthermore, components and/or functionality in either of these communication circuits may be implemented using hardware and/or software.

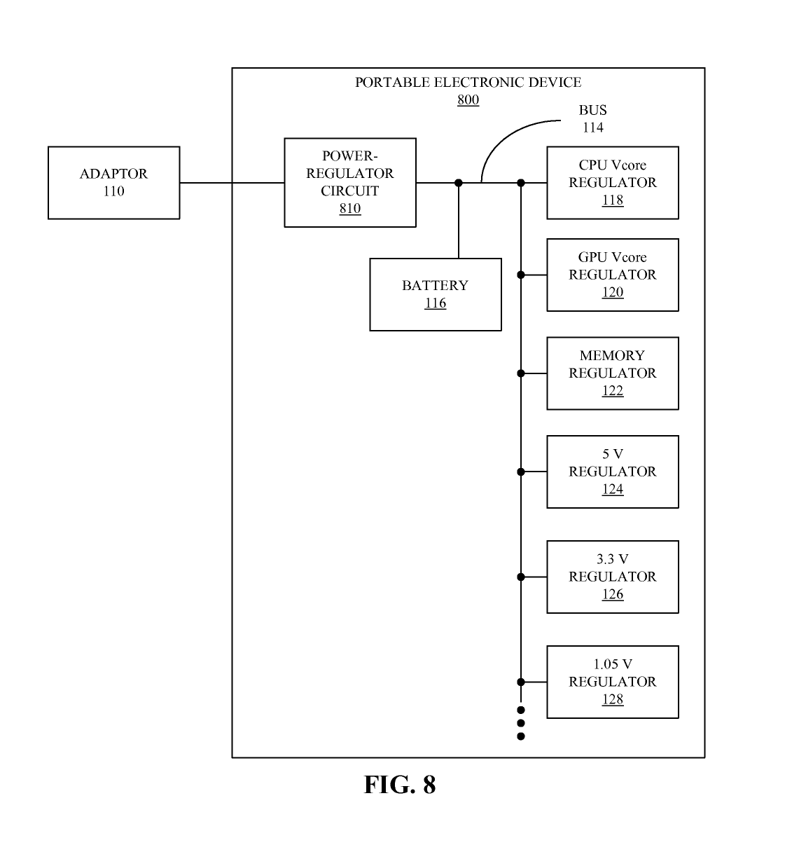

We now describe embodiments of a portable device. FIG. 8 presents a block diagram illustrating a portable electronic device 800 (such as a laptop computer) that includes a power-regulator circuit 810, such as power-regulator circuit 300 (FIG. 3) or 600 (FIG. 6). In some embodiments, the LDO circuit in power-regulator circuit 810 is only enabled when the portable electronic device 800 is in the OFF or SLEEP operating modes.

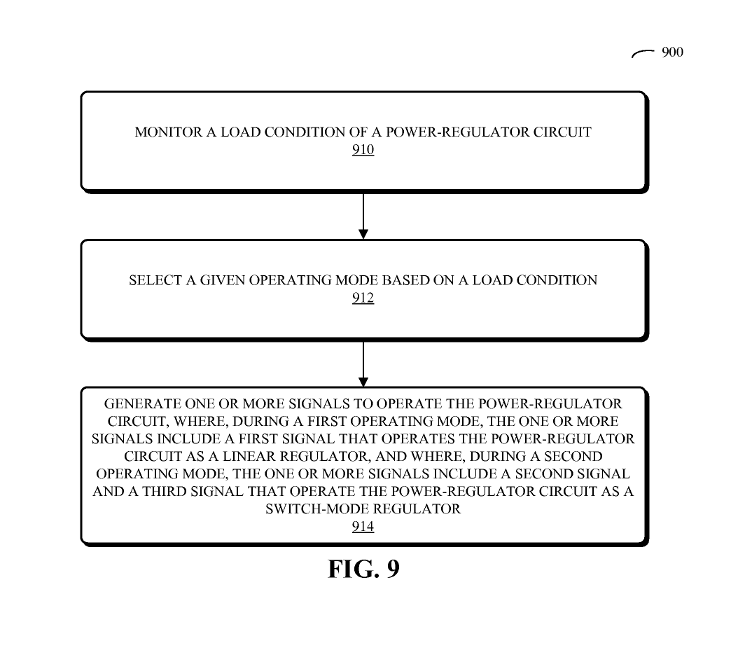

We now describe embodiments of a process for regulating power. FIG. 9 presents a flowchart illustrating a process 900 for regulating power using a power-regulator circuit that has two operating modes. During this process, a load condition of the power-regulator circuit is monitored (910) and a given operating mode is selected based on a load condition (912). Then, one or more signals to operate the power-regulator circuit are generated (914). Note that, during a first operating mode, the one or more signals include a first signal that operates the power-regulator circuit as a linear regulator. Moreover, during a second operating mode, the one or more signals include a second signal and a third signal that operate the power-regulator circuit as a switch-mode regulator.

In some embodiments, there may be additional or fewer operations. Moreover, the order of the operations may be changed and/or two or more operations may be combined into a single operation.

Devices and circuits described herein may be implemented using computer-aided design tools available in the art, and embodied by computer-readable files containing software descriptions of such circuits. These software descriptions may be: at behavioral, register transfer, logic component, transistor and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media or carrier waves may be done electronically over diverse media on the Internet or, for example, via email. Note that physical files may be implemented on machine-readable media such as: 4 mm magnetic tape, 8 mm magnetic tape, 3½ inch floppy media, CDs, DVDs, and so on.

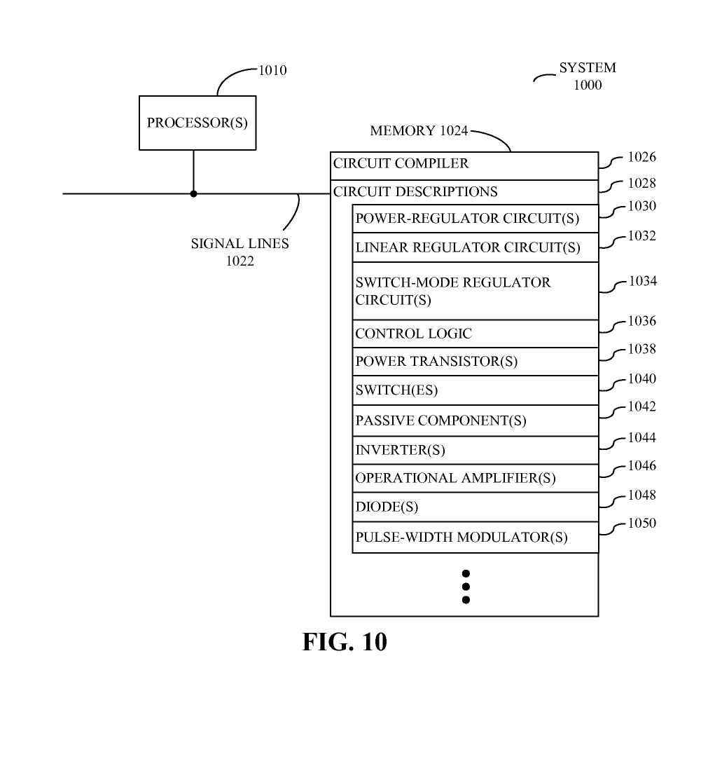

FIG. 10 presents a block diagram of a system 1000 that stores such computer-readable files. This system may include at least one or more processors 1010, memory 1024 and one or more signal lines or communication busses 1022 for coupling these components to one another. Memory 1024 may include high-speed random access memory and/or non-volatile memory, such as: ROM, RAM, EPROM, EEPROM, flash memory, one or more smart cards, one or more magnetic disc storage devices, and/or one or more optical storage devices.

Memory 1024 may store a circuit compiler 1026 and circuit descriptions 1028. Circuit descriptions 1028 may include descriptions of the circuits, or a subset of the circuits discussed above with respect to FIGS. 3-6. In particular, circuit descriptions 1028 may include circuit descriptions of: one or more power-regulator circuits 1030, one or more linear regulator circuits 1032, one or more switch-mode regulator circuits 1034, control logic 1036, one or more power transistors 1038, one or more switches 1040, one or more passive components 1042, one or more inverters 1044, one or more operational amplifiers 1046, one or more diodes 1048, and/or one or more pulse-width modulators 1050.

In some embodiments, system 1000 includes fewer or additional components. Moreover, two or more components may be combined into a single component and/or a position of one or more components may be changed.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A power-regulator circuit having two operating modes, comprising:
control logic configured to select a given operating mode based on a load condition of the power-regulator circuit, wherein, during a first operating mode, the control logic provides a first signal that operates the power-regulator circuit as a linear regulator; and
wherein, during a second operating mode, the control logic provides a second signal and a third signal that operate the power-regulator circuit as a switch-mode regulator.

2. The power-regulator circuit of claim 1, further comprising:
a linear regulator circuit;
a switch-mode regulator circuit;
a first power transistor coupled to a first node of the power-regulator circuit, which is configured to receive an input voltage; and
a switch, coupled to the control logic, the linear-regulator circuit and the switch-mode regulator circuit, to selectively couple the first signal from the linear regulator circuit to the first power transistor during the first operating mode and to selectively couple the second signal from the switch-mode regulator circuit to the first power transistor during the second operating mode.

3. The power-regulator circuit of claim 2, wherein the linear regulator circuit includes a low-dropout regulator circuit.

4. The power-regulator circuit of claim 2, wherein the switch-mode regulator circuit includes a buck regulator circuit.

5. The power-regulator circuit of claim 2, wherein the second signal from the switch-mode regulator circuit includes a pulse-width modulated signal.

6. The power-regulator circuit of claim 2, further comprising:
a second power transistor coupled in series with the first power transistor and coupled to a second node of the power-regulator circuit which is configured to couple to a reference voltage; and
an inverter, coupled to the control logic, to selectively provide the third signal to the second power transistor during the second operating mode, wherein the third signal is the inverse of the second signal.

7. The power-regulator circuit of claim 6, wherein the reference voltage is ground.

8. The power-regulator circuit of claim 6, wherein the reference voltage is a virtual ground.

9. The power-regulator circuit of claim 6, wherein an output from the inverter is selectively disabled during the first operating mode.

10. The power-regulator circuit of claim 6, wherein, during the first operating mode, an output from the inverter is selectively set to a lower impedance than during the second operating mode.

11. The power-regulator circuit of claim 6, wherein the first power transistor is shared during the first operating mode and the second operating mode.

12. The power-regulator circuit of claim 6, wherein the second power transistor is inactive during the first operating mode.

13. The power-regulator circuit of claim 6, wherein the power-regulator circuit provides an output voltage at a third node between the first power transistor and the second power transistor.

14. The power-regulator circuit of claim 13, wherein the load condition corresponds to a current at the third node; and
wherein the first operating mode has a higher efficiency, which corresponds to the input voltage and the output voltage, than the second operating mode for values of the current less than a threshold.

15. The power-regulator circuit of claim 14, wherein the threshold is approximately 100 mA.

16. The power-regulator circuit of claim 13, wherein the output voltage is provided by at most the first power transistor and the second power transistor during the two operating modes.

17. The power-regulator circuit of claim 1, wherein the power-regulator circuit is included in a portable electronic device.

18. The power-regulator circuit of claim 17, wherein the portable electronic device includes a laptop computer.

19. The power-regulator circuit of claim 1, wherein the power-regulator circuit is disposed on an integrated circuit.

20. A power-regulator circuit having two operating modes, comprising:
means for selecting a given operating mode based on a load condition of the power-regulator circuit, wherein, during a first operating mode, the means provides a first signal that operates the power-regulator circuit as a linear regulator; and
wherein, during a second operating mode, the means provides a second signal and a third signal that operate the power-regulator circuit as a switch-mode regulator.

21. A portable electronic device, comprising an integrated circuit that includes a power-regulator circuit having two operating modes, wherein the power-regulator circuit contains control logic configured to select a given operating mode based on a load condition of the power-regulator circuit;
wherein, during a first operating mode, the control logic provides a first signal that operates the power-regulator circuit as a linear regulator; and
wherein, during a second operating mode, the control logic provides a second signal and a third signal that operate the power-regulator circuit as a switch-mode regulator.

22. A computer-readable medium containing data representing a power-regulator circuit that has two operating modes, wherein the power-regulator circuit includes:
control logic configured to select a given operating mode based on a load condition of the power-regulator circuit, wherein, during a first operating mode, the control logic provides a first signal that operates the power-regulator circuit as a linear regulator; and
wherein, during a second operating mode, the control logic provides a second signal and a third signal that operate the power-regulator circuit as a switch-mode regulator.

23. A method for regulating power using a power-regulator circuit that has two operating modes, comprising:
monitoring a load condition of the power-regulator circuit;
selecting a given operating mode based on a load condition;
generating one or more signals to operate the power-regulator circuit, wherein, during a first operating mode, the one or more signals include a first signal that operates the power-regulator circuit as a linear regulator; and
wherein, during a second operating mode, the one or more signals include a second signal and a third signal that operate the power-regulator circuit as a switch-mode regulator.
